(19) United States
(12) Patent Application Publication
(10) Pub. No.: US 2015/0234488 A1
(43) Pub. Date: Aug. 20, 2015

(54) SYSTEM FOR INTEGRATING SMART DEVICE WITH VEHICLE

(71) Applicant: DENSO International America, Inc., Southfield, MI (US)

(72) Inventors: Martin NESPOLO, Grosse Pointe Woods, MI (US); Kyle GOLSCH, Pontiac, MI (US); Sibu VARUGHESE, Sterling Heights, MI (US); Vikas UPMANUE, Farmington Hills, MI (US); Yu ZHANG, Troy, MI (US); Justin MCBRIDE, South Lyon, MI (US); Laith DAMAN, Novi, MI (US); Cary HORVATH, Dearborn, MI (US); Thomas KRZYZAK, JR., Livonia, MI (US)

(21) Appl. No.: 14/623,141

(22) Filed: Feb. 16, 2015

Related U.S. Application Data
(60) Provisional application No. 61/940,689, filed on Feb. 17, 2014.

(51) Int. Cl. G06F 3/041; B60R 11/02

(52) U.S. Cl. CPC G06F 3/041; B60R 11/02

(57) ABSTRACT

A system for accessing functionality of a smart device in a vehicle. The system includes a connection system for connecting the smart device to a vehicle system. A vehicle interface is configured to access functionality of the smart device when the smart device is connected to the vehicle system. A controller of the vehicle interface is configured to access and control functionality of the smart device when the smart device is connected to the vehicle system.

### CROSS-REFERENCE TO RELATED APPLICATION

This application claims the benefit of U.S. Provisional Application No. 61/940,689 filed on Feb. 17, 2014, the entire disclosure of which is incorporated herein by reference.

### FIELD

The present disclosure relates to a system for integrating a smart device with a vehicle.

### BACKGROUND

This section provides background information related to the present disclosure, which is not necessarily prior art.

Portable smart devices, such as smart phones, tablets, and other portable computing devices, are often sources of distraction, particularly to teenage drivers. Accordingly, teenage drivers report the highest level of phone use during accidents and near accidents. Sending and responding to text messages, as well as setting up and scanning music play lists, are just a few ways teenage drivers may become distracted. Applications that minimize driver distraction, particularly distraction by teenage drivers, will likely increase driver focus on the primary task of driving. The present teachings thus advantageously provide for systems, devices, and methods for accessing functionality of a smart device in a manner that will minimize driver distraction.

### SUMMARY

This section provides a general summary of the disclosure, and is not a comprehensive disclosure of its full scope or all of its features.

The present teachings provide for a system for accessing functionality of a smart device in a vehicle. The system includes a connection system for connecting the smart device to a vehicle system. A vehicle interface is configured to access functionality of the smart device when the smart device is connected to the vehicle system. A controller of the vehicle interface is configured to access and control functionality of the smart device when the smart device is connected to the vehicle system.

The present teachings also provide for a system for accessing functionality of a smart device in a vehicle. The system includes a connection system for connecting the smart device to a vehicle system including at least one of communication, entertainment, or navigation functionality. A vehicle interface including a display is configured to access features of the smart device when the smart device is connected to the vehicle system. A touchpad of the vehicle interface is configured to access and control functionality of the smart device when the smart device is connected to the vehicle system.

The present teachings further provide for a system for accessing functionality of a smart device in a vehicle. The system includes a connection system for connecting the smart device to a vehicle system including at least one of communication, entertainment, or navigation functionality. A vehicle interface includes a display configured to access features of the smart device when the smart device is connected to the vehicle system. A storage location is configured to secure at least one smart device. A touchpad of the vehicle interface is configured to access and control functionality of the smart device when the smart device is connected to the vehicle system. The touchpad includes at least one customizable button, a main touch area, and at least one touch sensitive raised outer edge. The touchpad is configured to detect at least the following: horizontal, vertical, and circular touches at the main touch area; touch pressure; gestures; touches representing at least one of characters, symbols, letters, or numbers; a sliding touch along the at least one touch sensitive outer edge as a scroll command; and a sliding touch from the main touch area to the at least one touch sensitive raised outer edge as a command to change a display screen of the vehicle interface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a passenger cabin of a vehicle including a system for accessing functionality of a smart device in the vehicle according to the present teachings;

FIG. 2 illustrates a storage location of the passenger cabin for storing at least one smart device therein;

FIG. 3 illustrates a touchpad according to the present teachings for accessing smart device functionality, as well as functionality of any other suitable system;

FIG. 4 is another view of the touchpad of FIG. 3; and

FIG. 5 illustrates another touchpad according to the present teachings for accessing smart device functionality.

Corresponding reference numerals indicate corresponding parts throughout the several views of the drawings.

### DETAILED DESCRIPTION

Example embodiments will now be described more fully with reference to the accompanying drawings.

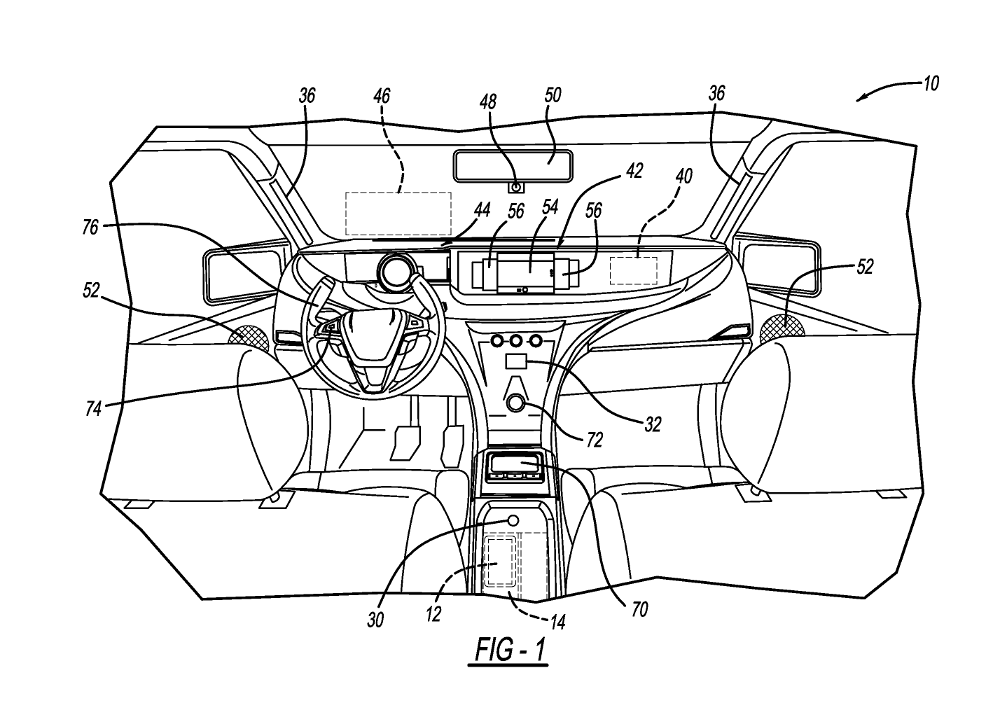

FIG. 1 illustrates a vehicle passenger cabin 10 including a system for accessing functionality of a smart device 12 in a manner that minimizes driver distraction. The passenger cabin 10 can be a passenger cabin of any suitable vehicle, such as a car, truck, sport utility vehicle (SUV), military vehicle, bus, aircraft, train, etc. The smart device 12 can be any suitable smart device, such as a smart phone, tablet computer, laptop computer, or any other suitable portable computing device.

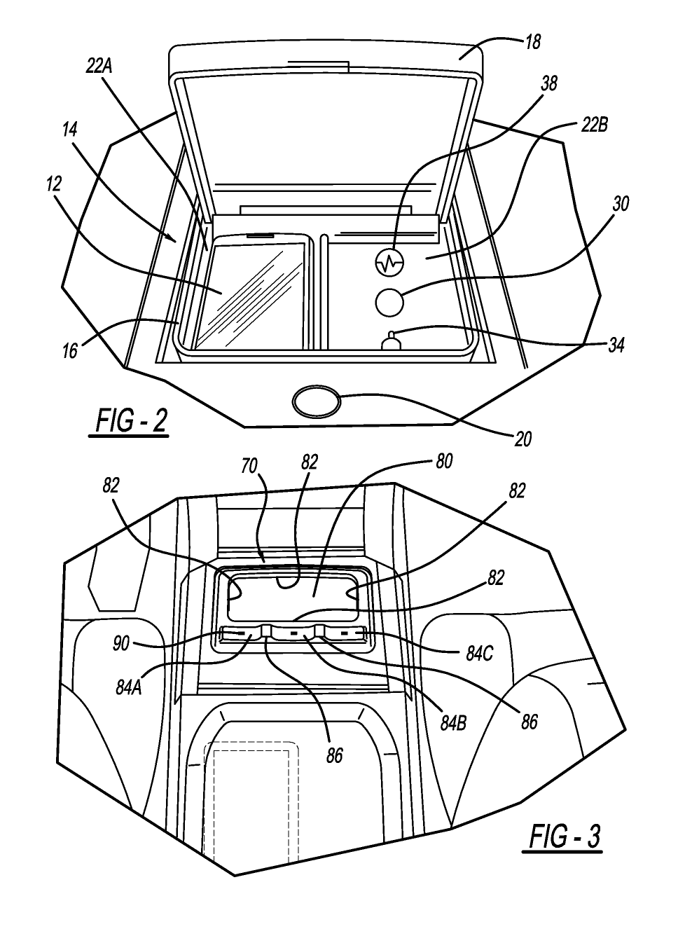

The passenger cabin 10 can include a storage location 14 for the smart device 12. The storage location 14 can be a ceremonial location for storing and securing the smart device 12 located at any suitable position throughout the passenger cabin 10. For example, the storage location 14 can be located at a center counsel between a driver's seat and a front passenger's seat, at an overhead location, or at door panels of the vehicle. With continued reference to FIG. 1 and additional reference to FIG. 2, the storage location 14 generally includes a case 16 configured to receive one or more smart devices 12 therein. The case 16 can be made of any suitable material, such as a metallic material. The case 16 can include a cover 18, which can be opened and closed in any suitable manner, such as by actuating a button 20. The case 16 can include any suitable number of storage bays, such as a first storage bay 22A and a second storage bay 22B as illustrated. Each one of the storage bays, such as the first storage bay 22A and the second storage bay 22B, can be configured to receive any suitable smart device, such as the smart device 12. Although the case 16 is illustrated as having two storage bays 22A and 22B, any suitable number of storage bays can be included.

The passenger cabin 10 includes any suitable connection device or system 30 configured to connect the smart device 12 to any suitable vehicle system, such as a vehicle communications system, entertainment system (including over the air broadcast radio and/or Internet radio), navigation system, climate control system, information system, heads-up display system, or any other suitable onboard system. The connection system 30 can be any suitable wired or wireless connection system. For example, any suitable wireless connection system, or combination of wireless connection systems, can be used, such as a Bluetooth connection system including a Bluetooth receiver/transmitter located at any suitable position throughout the passenger cabin 10, such as proximate to the storage location 14 as illustrated in FIG. 1, or within the storage location 14 as illustrated in FIG. 2. Other suitable connection systems 30 include cellular connection systems, near field communication (NFC) systems, Wi-Fi connection systems, etc. To facilitate initiation of the wireless connection, the passenger cabin 10 can include an RFID reader 32, or any other suitable reader, configured to read a device identification code from the smart device 12. For example, upon positioning of the smart device 12 in contact with, or in close proximity to, the RFID reader 32, the RFID reader 32 will read a device ID from the smart device 12 in order to connect the smart device 12 wirelessly to the vehicle system. Alternatively, the smart device 12 can be connected using a wired connection, such as by physically coupling the smart device 12 to any suitable physical connector, such as a plug 34 (FIG. 2) located at the storage location 14. The plug 34 can be any suitable plug, such as a micro USB plug. To encourage and facilitate use of the storage location 14 and supply power to the smart device 12, any suitable wireless or wired charging device 38 (FIG. 2) and/or system can be included within or proximate to the storage location 14.

Once the smart device 12 has been connected, occupants of the passenger cabin 10 can be notified of the connection in any suitable manner, such as with any suitable visual and/or audio notification. For example, the passenger cabin 10 can include connection indicators 36 located at A-pillars of the passenger cabin 10, which can illuminate after the connection has been made. The connection indicators 36 can include light emitting diodes (LED), for example.

The connection between the smart device 12 and the vehicle system can be performed and managed with any suitable device, such as a system control module 40. The system control module 40 can be any suitable controller, processor, and/or computing device configured to manage and carry out connection of the smart device 12 to any particular system of the passenger cabin 10, such as the vehicle communications system, entertainment system, navigation system, climate control system, information system, heads-up display system, or any other suitable onboard system.

The passenger cabin 10 further includes one or more vehicle interfaces configured to access and/or control functionality of the smart device 12 when the smart device 12 is connected, as well as access and/or control any other suitable vehicle system, such as the vehicle communications system, entertainment system, navigation system, climate control system, information system, heads-up display system, etc. For example, the vehicle interface can include a dashboard display 42, an instrument cluster 44, a heads up display (HUD) 46, a microphone 48 at rearview mirror 50 (or at any other suitable location within the passenger cabin 10), one or more audio speakers 52, a touchpad 70, a wheel or knob 72, controls 74 mounted to steering wheel 76, or any other suitable controller.

The dashboard display 42 can be located at any suitable position about a dashboard of the passenger cabin 10, such as at a generally centered position between driver and front passenger seats as illustrated. The dashboard display 42 can be configured in any suitable manner in order to allow occupants within the passenger cabin 10 to access and control functionality of the connected smart device 12, or any other suitable vehicle system. For example, the dashboard display 42 can include a plurality of windows or tiles, such as a selected tile 54 and one or more additional available tiles 56. Each tile 54/56 can include one or more functions of the smart device 12, with similar and related functions being included on the same tile. For example, the selected tile 54 can include functions related to searching for and playing songs and/or movies stored on the smart device 12. One of the available tiles 56 may include communications functionality, such as retrieving contact information from an address book, retrieving and/or composing a text message, and/or initiating and/or answering a telephone call. Another one of the available tiles 56 may include navigation functionality, and yet another one of the available tiles 56 may include functionality for searching the internet. Separate ones of the available tiles 56 may include functionality for each application present on the smart device 12.

The available tiles 56 and the functionality of the selected tile 54 may be selected in any suitable manner, such as by using any suitable controller of the vehicle interface, including the wheel or knob 72, controls 74 of the steering wheel 76, or the touchpad 70 as described herein. The available tiles 56 and the functionality of the selected tile 54 can also be selected using voice commands input at the microphone 48. Audio confirmation of the selection can be generated by the speakers 52.

With respect to the instrument cluster 44 and the HUD 46, they can be configured in any suitable manner to access functionality of the smart device 12 as well. For example, the instrument cluster 44 and/or the HUD 46 can include a navigation display configured to display navigation information retrieved from the smart device 12.

Functionality of the smart device 12 can further be accessed using voice commands input through the microphone 48. Voice feedback can be generated at the smart device 12 or by the system control module 40, and broadcast from speakers 52. Any suitable voice feedback can be generated, such as confirmation of selected functionality and/or navigation voice commands.

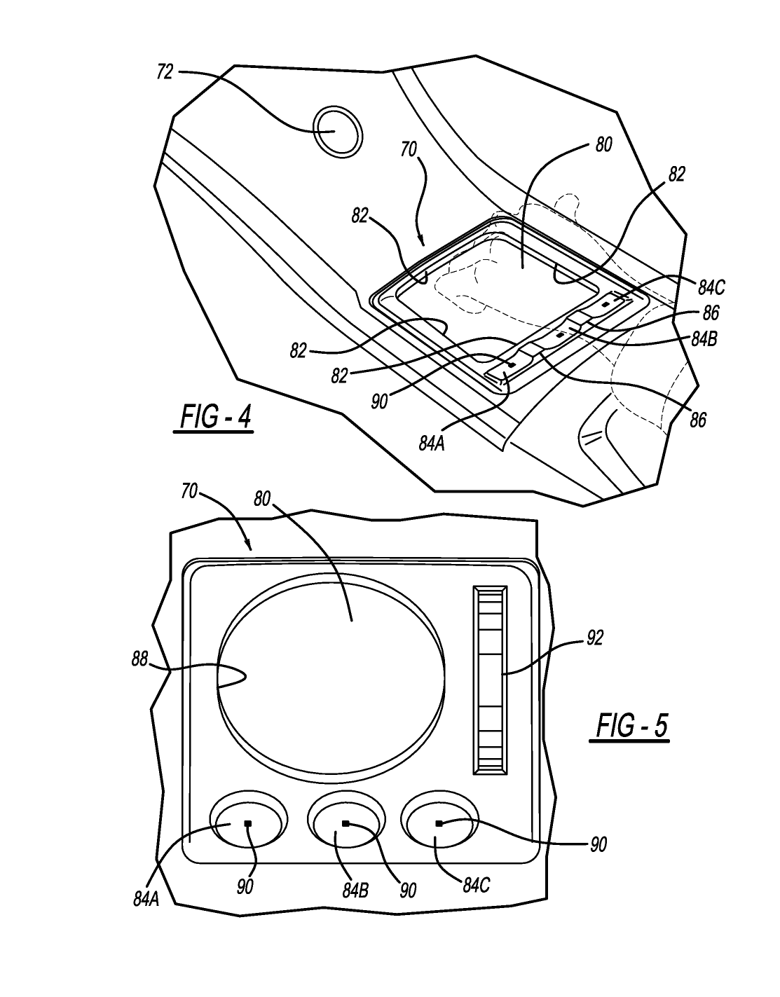

With reference to FIGS. 3 and 4, the touchpad 70 will now be described in further detail. The touchpad 70 is an exemplary controller of the vehicle interface and is configured to control and access functionality of the smart device 12, as well as any other suitable vehicle system. The touchpad 70 generally includes a main touch area 80 and touch sensitive outer edges 82. The outer edges 82 can be raised relative to the main touch area 80, and thus the main touch area 80 can be recessed beneath the touch sensitive outer edges 82. The main touch area 80 can have any suitable shape or size, such as a generally rectangular or square shape as illustrated in FIGS. 3 and 4, or a generally circular shape as illustrated in FIG. 5. Any suitable number of the outer edges 82 can be included. For example, and as illustrated in FIGS. 3 and 4, four touch sensitive outer edges 82 can be included, which together surround the main touch area 80. As illustrated in FIG. 5, when the main touch area 80 is circular, a continuous circular touch sensitive outer edge 88 may be included.

The touchpad 70 can be any suitable touchpad manufactured in any suitable manner. For example, the touchpad 70 may include an outer covering, an intermediate tactile layer configured to detect finger touches and movement, and a pressure pad bottom layer. Therefore, the touchpad 70 is configured to measure pressure of a touch, as well as locations of individual touches, sliding touches, and gestures in any direction, such as horizontal, vertical, circular, and in any other direction, as well as touches that change direction. The touchpad 70 is also configured to recognize touches representing characters, letters, symbols, and/or hand signals/signs, such as sliding touches and/or gestures. The touchpad 70 may be configured to provide haptic feedback to a user thereof, such as when the user uses the touchpad 70 to select a particular function of the smart device 12.

The touch sensitive edges 82 and 88 provide numerous advantages. For example, the edges 82 and 88 provide a physical bumper or stop for a user's finger, which when contacted by the user's finger notifies the user that his or her finger has reached an edge of the touchpad 70. The edges 82 and 88 can thus facilitate operation of the touchpad 70 without the need to look at the touchpad 70, thereby minimizing driver distraction by allowing a driver to keep his or her eyes on the road.

The touchpad 70 can further include one or more buttons 84, which can be customizable. Any suitable number of buttons 84 can be included, such as three buttons 84A, 84B, and 84C as illustrated. The buttons 84A-84C can be located at any suitable position proximate to the main touch area 80, such as slightly below the main touch area 80 as illustrated. To facilitate locating the buttons 84A-84C without having to look at them, which will allow a driver to keep his or her eyes on the road, the buttons 84A-84C may be raised with respect to the main touch area 80 and the touch sensitive outer edges 82 and 88, as illustrated in FIG. 3. To facilitate distinguishing between each one of the buttons 84A-84C, any suitable divider can be provided between the buttons 84A-84C. For example, and as illustrated in FIG. 3, a raised ridge 86 can be between the buttons 84A and 84B, as well as between the buttons 84B and 84C. With reference to FIG. 5, the buttons 84A-84C can be recessed, such as recessed beneath the continuous circular touch sensitive outer edge 88, to facilitate locating the buttons 84A-84C without the driver having to take his or her eyes off of the road. Each one of the buttons 84A-84C can include any suitable indicator to facilitate identification of the particular function of the buttons 84A-84C, such as graphic indicators 90. The graphic indicators 90 can represent a particular function, such as a home function when the graphic indicator 90 is a picture of a house, or the graphic indicators 90 can merely be different shapes, symbols, graphics, etc. to help a user distinguish between the buttons 84A-84C.

As illustrated in FIG. 5, the touchpad 70 can further include a dedicated scrolling area 92. The scrolling area 92 generally extends vertically, and can be recessed beneath the outer edge 88 and/or the main touch area 80. FIG. 5 illustrates the recessed scrolling area 92 included when the main touch area 80 is circular and surrounded by the continuous circular touch sensitive outer edge 88, but the recessed scrolling area 92 can be included in the configuration of FIG. 3 in which the main touch area 80 is generally square or rectangular and the outer edges 82 are generally straight. The scrolling area 92 can be included in any other suitable configuration as well, and have any suitable shape and size.

Exemplary use of the touchpad 70 will now be described. In order to navigate through the available tiles 56 before choosing the selected tile 54, the touchpad 70 can be used in any suitable manner, such as by touching any one of the touch sensitive outer edges 82/88. For example, in order to select available tiles 56 on a right-hand side of the selected tile 54, the outer edge 82 positioned on the right-hand side of the main touch area 80 can be touched. To select available tiles 56 on a left-hand side of the selected tile 54 as displayed on the dashboard display 42, the outer edge 82 on a left-hand side of the main touch area 80 may be touched. The touches at the outer edges 82/88 can be configured as a sliding touch starting at an area of the main touch area 80 spaced apart from the outer edges 82/88, and sliding towards any of the outer edges 82/88. The available tiles 56 can also be scrolled through with a sliding touch arranged along any one or more of the edges 82.

If the dashboard display 42 is configured differently than as illustrated in FIG. 1, such as with the available tiles 56 arranged on the top and/or bottom of the selected tile 54, available tiles 56 on the top of the selected tile 54 can be selected by pressing the outer edge 82 at the top of the main touch area 80. Available tiles 56 arranged beneath the selected tile 54 can be selected by pressing the outer edge 82 at the bottom of the main touch area 80. The available tiles 56 can also be chosen as the selected tile 54 by pressing any one of the buttons 84A-84C, depending on how the buttons 84A-84C have been customized. Further, a portion of the main touch area 80 may be touched multiple times, such as with a double tap, to select one of the available tiles 56.

The dashboard display 42 may also be configured such that the tiles 54 and 56 are arranged as circular tiles along a circle or a wheel displayed on the dashboard display 42. Thus the circular tiles 54 and 56 may be cycled through in a circular manner. When the dashboard display 42 is configured in this circular manner, the main touch area 80 can be provided with a circular shape as illustrated in FIG. 5 and the main touch area 80 can be surrounded by the continuous circular touch sensitive outer edge 88. In order to cycle through the tiles 54 and 56, the user can slide his or her finger along the continuous circular touch sensitive outer edge 88.

After one of the available tiles 56 is chosen as the selected tile 54, features of the selected tile 54 can be selected using the touchpad 70 in any suitable manner. For example, if the selected tile 54 includes a plurality of songs or playlists to be played, the songs and/or playlists can be cycled through with a sliding touch in a horizontal, vertical, or circular direction about the main touch area 80. The horizontal, vertical, and circular touches can control a cursor or highlighted area on the dashboard display 42, for example. Alternatively, any one of the outer edges 82 or the circular outer edge 88 can be touched, or the sliding touch may be made along the edges 82 or 88. Desired functionality can be selected in any suitable manner, such as by tapping the main touch area 80, tapping the outer edges 82/88, or pressing one of the buttons 84A-84C.

The touchpad 70 can be used to access functionality of the smart device 12, and also can be used in a similar manner to access any functionality made available apart from the smart device 12 by any system of the vehicle, such as navigation functionality provided by a navigation system installed within the passenger cabin 10, an entertainment system installed within the passenger cabin 10 including a radio of the passenger cabin 10, the HUD 46, features of the instrument cluster 44, and system settings of the vehicle, for example. The touchpad 70 can thus be used to access and control any suitable system of the vehicle. The touchpad 70 can further provide search functionality. The touch pad 70 can be used to run any suitable search, such as, for example, a search for functionality available for control, a song or playlist search, an address/location search, a business search, a restaurant search, a landmark search, an Internet search, etc. The search request can be input using the touch pad 70 in any suitable manner. For example, the search request can be input using the character recognition and/or gesture recognition features of the main touch area 80 of the touch pad 70.

Default actions for the buttons 84A-84C can include home, back, search, and/or select for example. The buttons 84A-84C can have a number of different operating states, which can include the following: selected, unselected, and viewed. The viewed state can enable a user to touch any one of the buttons 84A-84C to identify what functions it performs without selecting the function. The function of the touched button 84A-84C can be conveyed to persons in the passenger cabin 10 in any suitable manner, such as by being displayed on the dashboard display 42 or the HUD 46, for example. The viewing configuration can be determined based on an amount of force exerted on any one of the buttons 84A-84C.

The present teachings are advantageous because they remove potential distractions in a variety of different ways. For example, the present teachings remove potential distractions presented when a driver holds the smart device 12 in his or her hand by providing the storage location (or ceremonial location) 14 for the smart device 12 that allows the smart device 12 to connect to the vehicle, such as by way of a wireless connection. Features of the smart device 12 that are compatible with the vehicle's communications and entertainment system (such as messaging, music selection, etc.), or any other suitable vehicle system, are accessible through the pressure-sensitive touchpad 70, which manipulates the vehicle center stack display, such as the dashboard display 42 for example. The present teachings thus increase driver safety by allowing the driver to operate his/or her smart device 12 without holding it, which eliminates a major source of distraction. Functionality from the smart device 12 is still available to the driver, but through systems of the vehicle, such as the vehicle's communications and entertainment system, for example.

The description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted accordingly.

What is claimed is:

1. A system for accessing functionality of a smart device in a vehicle comprising:
a connection system for connecting the smart device to a vehicle system;
a vehicle interface configured to access functionality of the smart device when the smart device is connected to the vehicle system; and
a controller of the vehicle interface configured to access and control functionality of the smart device when the smart device is connected to the vehicle system.

2. The system of claim 1, wherein the connection system is wireless.

3. The system of claim 1, wherein the connection system includes a wired connection.

4. The system of claim 1, further comprising:
a storage location configured to secure the smart device, the storage location configured to accommodate at least one smart device; and
a smart device charger at or proximate to the storage location, the smart device charger configured to charge the smart device at least one of wirelessly or through a wired connection.

5. The system of claim 1, wherein the vehicle system includes at least one of a communications system, an entertainment system, and a navigation system; and
wherein the controller is configured to control the vehicle system.

6. The system of claim 1, wherein the vehicle interface includes at least one of a heads-up display, an instrument cluster display, a dashboard display, audio speakers, or a microphone.

7. The system of claim 1, wherein the controller includes at least one of a touchpad, a rotary knob, a touch screen, a joystick, a knob, a lever, a button, a switch, or a wheel.

8. The system of claim 1, wherein the controller includes a circular touchpad surrounded by a circular touch sensitive outer edge.

9. The system of claim 1, wherein the controller includes a touchpad having four touch-sensitive sides.

10. The system of claim 1, wherein the controller includes a touchpad having at least one customizable button.

11. The system of claim 1, wherein the controller includes a scroll pad.

12. The system of claim 1, wherein:
the controller includes a touchpad having a main touch area and at least one touch sensitive raised outer edge;
the touchpad is configured to provide haptic feedback; and
the touchpad is configured to detect at least the following:
horizontal, vertical, and circular touches as commands for moving a cursor;
gestures;
touches representing at least one of characters, symbols, letters, or numbers;
touch pressure;
a sliding touch along the at least one touch sensitive outer edge as a scroll command; and
a sliding touch from the main touch area to the at least one touch sensitive raised outer edge as a command to change a display screen of the vehicle interface.

13. A system for accessing functionality of a smart device in a vehicle comprising:
a connection system for connecting the smart device to a vehicle system including at least one of communication, entertainment, or navigation functionality;
a vehicle interface including a display configured to access features of the smart device when the smart device is connected to the vehicle system; and
a touchpad of the vehicle interface configured to access and control functionality of the smart device when the smart device is connected to the vehicle system.

14. The system of claim 13, wherein the touchpad includes a main touch area and at least one touch sensitive raised outer edge.

15. The system of claim 14, wherein the touchpad is configured to detect at least the following:
horizontal, vertical, and circular touches at the main touch area as commands for moving a cursor;
gestures;
touches representing at least one of characters, symbols, letters, or numbers
touch pressure;
a sliding touch along the at least one touch sensitive outer edge as a scroll command; and
a sliding touch from the main touch area to the at least one touch sensitive raised outer edge as a command to change a display screen of the vehicle interface.

16. The system of claim 13, wherein the touchpad includes at least one customizable button.

17. The system of claim 13, further comprising a storage location configured to secure the smart device therein, the storage location configured to accommodate at least one smart device.

18. A system for accessing functionality of a smart device in a vehicle comprising:
a connection system for connecting the smart device to a vehicle system including at least one of communication, entertainment, or navigation functionality;
a vehicle interface including a display configured to access features of the smart device when the smart device is connected to the vehicle system;
a storage location configured to secure at least one smart device; and
a touchpad of the vehicle interface configured to access and control functionality of the smart device when the smart device is connected to the vehicle system, the touchpad including at least one customizable button, a main touch area, and at least one touch sensitive raised outer edge, the touchpad is configured to detect at least the following:
horizontal, vertical, and circular touches at the main touch area;
touch pressure;
gestures;
touches representing at least one of characters, symbols, letters, or numbers;
a sliding touch along the at least one touch sensitive outer edge as a scroll command; and
a sliding touch from the main touch area to the at least one touch sensitive raised outer edge as a command to change a display screen of the vehicle interface.

19. The system of claim 18, wherein the main touch area and the touch sensitive raised outer edge are circular, the touch sensitive raised outer edge surrounds the main touch area.

20. The system of claim 18, wherein the main touch area has four sides, and the touchpad includes four touch sensitive raised outer edges surrounding the main touch area.
